(19) United States
(12) Patent Application Publication
(10) Pub. No.: US 2026/0362551 A1
(43) Pub. Date: Nov. 12, 2026

(54) Electric Heating Apparatus

(71) Applicant: Eberspächer catem GmbH & Co. KG, Herxheim (DE)

(72) Inventors: Jikang Wang, Rulzheim (DE); Philip Rabe, Neustadt an der Weinstrasse (DE); Timo Kröner, Rulzheim (DE)

(21) Appl. No.: 19/671,489

(22) Filed: May 8, 2026

(30) Foreign Application Priority Data
May 8, 2025 (DE) 102025117693.0

(51) Int. Cl. H05B 1/02; H05B 3/82

(52) U.S. Cl. CPC H05B 1/0236; H05B 3/82; H05B 2203/021

(57) ABSTRACT

An electric heating apparatus for a motor vehicle includes a housing and a heating device. The housing surrounds a heating chamber and has inlet and outlet ports for a medium to be heated. The electric heating device is thermally coupled to the heating chamber via a partition wall. An inlet flow path, extending from the inlet port, and an outlet flow path, leading to the outlet port, are formed in the housing, the inlet flow path and the outlet flow path enclosing the heating chamber between them. A plurality of flow-directing elements are arranged in the heating chamber to direct the flow within the heating chamber. Flow channels are formed between the flow directing elements and extend between the inlet flow path and the outlet flow path, the flow channels branching off from the inlet flow path and feed into the outlet flow path.

### BACKGROUND INFORMATION

### 1. Field of the Invention

The present invention relates to an electric heating apparatus, in particular for a motor vehicle.

### 2. Background of the Invention

The electric heating apparatus has a housing that surrounds a heating chamber and includes inlet and outlet ports provided on the housing for connecting lines - typically in the form of hoses - for a medium to be heated in the heating chamber. Furthermore, the electric heating apparatus comprises an electric heating device that is thermally coupled to the heating chamber via a partition wall. The partition wall serves to separate the electric heating device from the medium in such a way that, on the one hand, it prevents the live parts of the electric heating device from coming into contact with the medium to be heated, which is usually a liquid. On the other hand, however, it should also allow for the best possible heat transfer between the electric heating device and the medium to be heated through the partition wall.

The heating chamber is arranged within the housing between an inlet flow path extending from the inlet port and an outlet flow path leading to the outlet port. The inlet flow path and the outlet flow path are essentially parallel to one another and are formed within the heating chamber. Such an electric heating device is known, for example, from DE 10 2020 123 996 A1. In this prior art, the flow is guided in a U-shape within a heating chamber that is essentially U-shaped overall. Heating fins extend between the partition wall and an opposite cover; these are intended to improve the surface area for heat transfer and also partially align and guide the flow within the heating chamber.

For the heating device to perform well, it is not only desirable to have a heat transfer path from the electric heating element to the heating chamber that is as short as possible and has low thermal resistance. Rather, the flow within the heating chamber must also meet various requirements. For example, the flow must be directed past the heat-emitting partition wall in such a way that the heat is absorbed as effectively as possible by the electric heating element. In this context, as uniform a heat transfer as possible across the surface plays a role. The medium should also be heated uniformly within the heating chamber so that partial flows passing through different areas of the heating chamber are essentially heated in such a way that not only does the inflowing fluid have a uniform temperature, but also the fluid that converges in the outlet flow path and passes through the heating chamber in partial flows. Furthermore, the medium to be heated should pass through the heating chamber with as little effective pressure loss as possible.

### SUMMARY OF THE INVENTION

In view of these various requirements and to solve at least some of the above-mentioned problems, the present invention proposes arranging a plurality of flow-directing elements in the heating chamber, thereby forming flow channels between the flow-directing element to direct the flow through the heating chamber. The flow channels extend between the inlet flow path and the outlet flow path. The flow channels branch off from the inlet flow path and open into the outlet flow path. Since the inlet flow path and the outlet flow path extend essentially parallel to and at a distance from one another, the flow-directing elements are located between these two flow paths, such that, macroscopically, the flow channels partition off partial flows and transfer them from the inlet flow path to the outlet flow path. These sub-flows essentially traverse the heating chamber in a direction transverse to the main direction of extension of the inlet and outlet flow paths. In other words, the fluid to be heated is essentially guided through the heating chamber in a U-shape, but is divided into sub-flows between the inlet and outlet flow paths, i.e. said sub-flows correspond to the web of the U-shape of different U-shaped paths, where each U-shaped path includes a different flow-channel. The flow-directing means may be provided as flow-guiding ribs.

The electric heating device may be arranged relative to the heating chamber such that the heat-generating region of the electric heating device is positioned merely opposite the flow channels, and accordingly, the flow paths for the inlet and outlet serve only to guide the flow but are not directly associated with the electric heating device. However, the inlet flow path and/or the outlet flow path may also be covered by the heat-emitting surfaces of the electric heating device and thus by the partition wall, so that heating of the medium can also take place in these inlet and outlet flow paths. The medium to be heated can be a liquid.

According to an embodiment of the present invention, the flow-guiding ribs extend parallel to one another. This does not necessarily imply that the flow-guiding ribs extend in a straight line next to one another. Rather, this configuration is intended in particular to ensure that the individual flow channels between the parallel flow-guiding ribs have a width that essentially remains constant along their entire length. As mentioned previously, the flow channels may extend macroscopically at right angles to the inlet flow path and the outlet flow path. While each individual flow channel should generally have a flow cross-section that is as uniform as possible along its longitudinal extent, the flow cross-section of the inlet flow path may decrease steadily with increasing distance from the inlet nozzle. The same may also apply to the flow cross-section of the outlet flow path and/or the flow channel.

The inlet and outlet flow paths should be designed such that they ensure essentially identical flow velocities along their entire length. Since the inlet flow branches from the inlet flow path into each flow channel branching off at essentially right angles, a reduced volumetric flow results in the inlet flow path as the distance from the inlet nozzle increases; this, combined with the flow cross-section discussed here - which decreases with distance from the inlet port - leads to a flow velocity that is as uniform as possible along the length of the inlet flow path. The same applies to the outlet flow path as it incorporates an increasing number of sub-flows fed into the outlet flow path through the various flow channels.

To reduce flow resistance, the following modifications are proposed. The flow cross-section of the flow channels may decrease continuously with increasing distance from an inlet of the inlet flow path to an end of the inlet flow path. Alternatively, or additionally, the flow cross-section of the inlet flow path may decrease continuously with increasing distance from the inlet port, while the flow cross-section of the outlet flow path decreases continuously with increasing distance from the outlet port. The same applies to the distance between adjacent flow-guiding ribs. The inlet port and the inlet flow path may lie in the same plane. The inlet flow may path extend in line with the inlet port. The outlet port and the outlet flow path may lie in a single plane, and the outlet flow path may extend in line with the outlet port.

The flow cross-section of the inlet flow path or the outlet flow path may vary continuously. With a view to achieving a flow path with as little loss as possible, it is understood that steps and sharp edges within the contours of the heating chamber swept by the flow should be avoided. In this respect as well, according to an embodiment of the present invention, it is proposed that the inlet port and the inlet flow path lie in a single plane and/or that the outlet port and the outlet flow path lie in a single plane. In this case, the inlet flow path may lie in line with the inlet port. The outlet flow path also may extend in line with the outlet port. For this embodiment, it is not necessary for the inlet flow path and the inlet port to be arranged coaxially with respect to one another in the sense that the typically cylindrical inlet port is aligned with the central longitudinal axis of the inlet flow path. The same applies to the outlet flow path. It is sufficient that there is no offset between the inlet port and the inlet flow path or between the outlet port and the outlet flow path in at least one conceivable plane, so that the flow can be transferred between the port and the flow path with as little loss as possible.

Since the flow within the electric heating device physically suffers a certain loss of effective pressure as the distance from the inlet port increases, it is proposed that the cross-sectional area of the flow channels be allowed to increase as the distance from an inlet of the inlet flow path to an end of the inlet flow path increases. The flow cross-section may increase continuously or in sections. However, it is not necessary for it to increase continuously as the distance from an inlet of the inlet flow path to an end of the inlet flow path increases. For example, several flow channels lying next to one another may have the same flow cross-section and/or at least the same width.

To generate a certain degree of microcirculation and to extend the effective length of the flow path, the flow channels may be arranged in a wavy pattern. To ensure a low-loss transition of the flow from the inlet flow path into the flow channel, such wavy flow channels may have an inlet formed by the free end of the flow-guiding ribs, which rises to a crest located away from the inlet of the inlet flow path. The outlet of the wave-shaped flow channel is designed in a corresponding manner. It may rise to a crest located at a distance from the outlet of the outlet flow path. Thus, the flow channels at their mouths, or the flow-guiding ribs at their free ends, are oriented obliquely toward the inlet or outlet port relative to the flow path. Thus, the flow within the flow channels is always transferred into the inlet flow path or diverted from the outlet flow path with a velocity component that corresponds to the direction of the main flow in the outlet flow path or the inlet flow path. In this way, the flow can be guided with as little loss of efficiency as possible.

As mentioned, the flow-guiding ribs form an inlet to the flow channel. Their free ends may be arranged at an angle to the inlet flow path of between 10° and 60°, and more typically between 35° and 55°. A corresponding angle range is also provided in the area of the free ends of the flow channel’s outlet to the outlet flow path. With this inclination, the outlet of the flow formed by the flow-guiding ribs is also directed at an angle to the outlet flow path.

The inclination of the flow-guiding ribs at the inlet and outlet to the flow channels typically naturally adopts the waveform and continues into it. The flow-guiding ribs may comprise between 3 and 6 waves per 100 mm of the distance between the inlet flow path and the outlet flow path.

### BRIEF DESCRIPTION OF THE DRAWINGS

Further details and advantages of the present invention are apparent from the following description in conjunction with the drawing, the drawing showing

FIG. 1 A perspective side view of an embodiment of the invention.

FIG. 2 A top view of the heating chamber of the embodiment shown in FIG. 1 and

FIG. 3 A sectional view along line III-III as shown in FIG. 2.

### DETAILED DESCRIPTION

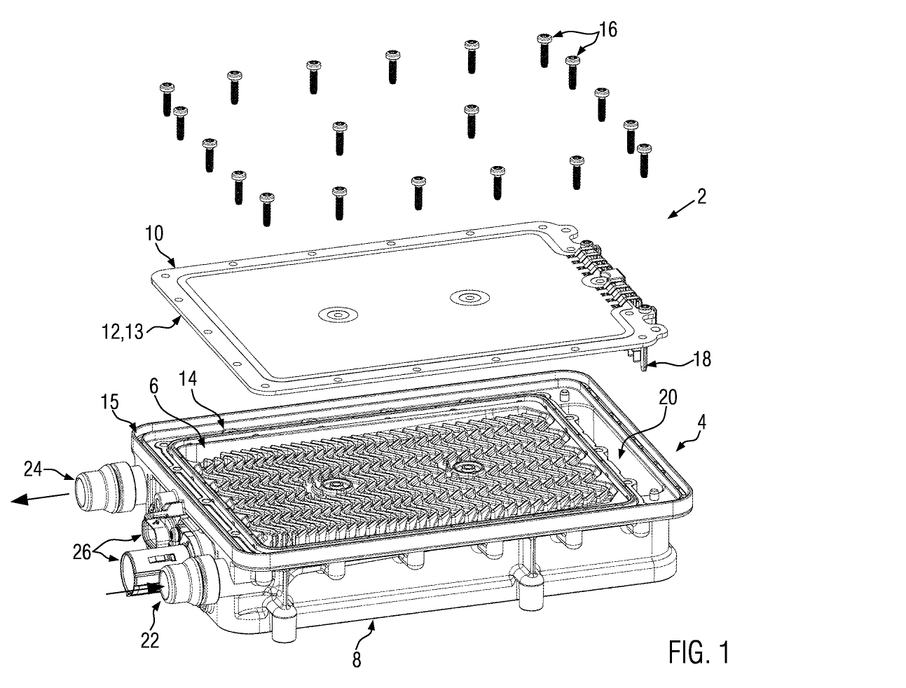

In the figures, reference numeral 2 denotes a housing which, in an embodiment, comprises a metal housing base 4 that forms a heating chamber 6 on one side and a connection chamber 8 on the opposite main side, the latter being suitable formed for the electrical connection and, where appropriate, the control of an electric device designated by reference numeral 10. The heating chamber 6 is formed between a heating chamber base, formed by the housing base 4, and a heating chamber cover 13. The electric heating device 10 is a flat resistance heater which, on its side facing the heating chamber 6, forms a partition wall 12 that delimits the heating chamber 6 on the side of the heating device 10. As shown in FIG. 1, the housing base 4 forms a sealing groove 14 for a seal (not shown), against which a peripheral edge of the partition wall 12 abuts. The housing base part 4 also forms an outer sealing groove 15 for another seal, also not shown, against which a housing cover, not shown, rests, covering the electric heating device 10.

The electric heating device 10 is secured to the housing base 4 using screws 16. Electrical contact elements 18 protrude from the flat electric heating device 10 toward and into the electrical connection chamber 8 for electrical connection, for which purpose the housing base 4 forms a passage 20 that extends continuously from the heating chamber side to the connection chamber side.

The housing base 4 forms an inlet port 22 and an outlet port 24. The ports 22 and 24 are cylindrical in shape and are designed to accommodate lines for a fluid to be heated in a motor vehicle. The ports 22 and 24 extend parallel to one another. Between the ports 22 and 24, electrical plug housings 26 can be seen, whose electrical connection elements extend into the connection chamber 8 in order to connect a control device - typically provided there - to power supply and to control signals.

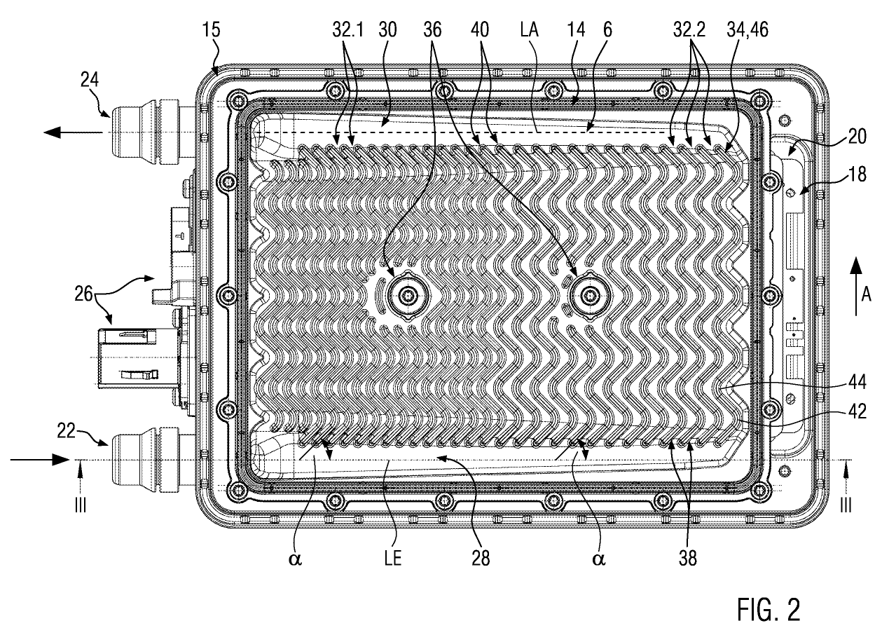

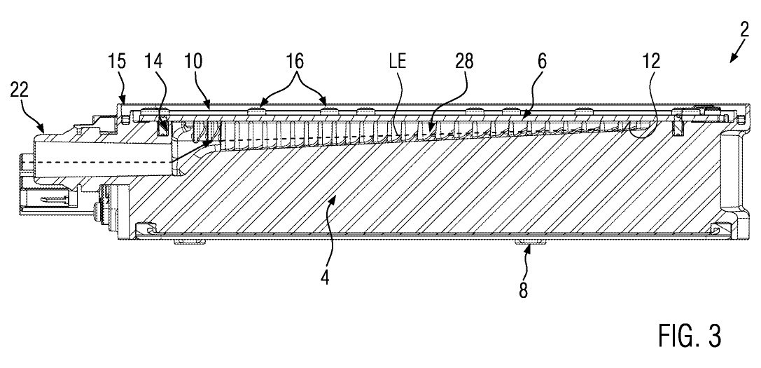

Reference numeral 28 in FIG. 2 denotes an inlet flow path arranged in line with the inlet port 22 and between the heating chamber base and the partition wall 12. The inlet flow path 28 extends in a plane with the inlet port 22, wherein this plane corresponds to the section plane shown in FIG. 2. In a plane transverse to this, the inlet flow path 28 is slightly offset relative to the inlet port 22 (see FIG. 3). The same applies to an outlet flow path, designated by reference number 30, with respect to the outlet port 24. This outlet flow path 30 is also formed between the heating chamber base and the partition wall 12. The inlet flow path 28 and the outlet flow path 30 define the heating chamber 6 between them.

As shown in particular in FIG. 2, a large number of flow channels 32.1 and 32.2 extend between the inlet flow path 28 and the outlet flow path 30; these flow channels are formed between flow-guiding ribs 34. With the exception of two mounting areas designated by reference numeral 36, in which the electric heating device 10 is secured relative to the housing base 4 via screws and, during assembly, the electric heating device is also positioned against the flow-guiding ribs 34, the two mounting areas being located centrally within the heating chamber 6, the flow-guiding ribs 34 and, accordingly, the flow channels 32.1 and 32.2 between the inlet flow path 28 and the outlet flow path 30 are formed as a continuous structure. The top view according to FIG. 2 further illustrates that the flow channels 32.1 that are located closer to the ports 22 and 24 have a smaller width than the flow channels 32.2 that are located further away from the ports. In the embodiment shown, flow channels of two different widths 32.1 and 32.2 are realized. Reference sign A indicates the main extension direction of the flow channels 32.1 and 32.1. As shown in the cross-sectional view of FIG. 3, the height of the heating chamber 6 decreases with increasing distance from the ports 22, 24. This results, on the one hand, in a decreasing flow cross-section of the inlet flow path 28 or the outlet flow path 30 with increasing distance from the respective ports 22, 24. On the other hand, the actual flow cross-section of the individual flow channels 32.1 and 32.2 also changes with increasing distance from the inlet or outlet side, although the width of individual flow channels 32.1 and 32.2, as shown in FIG. 2, can be constant for the whole length of the flow channels.

FIG. 2 illustrates a wave-shaped or undulatory configuration of the flow-guiding ribs 34 and, accordingly, of the flow channels 32, which extend macroscopically at right angles to the inlet and outlet flow paths 28, 30. The flow-guiding ribs 34 are each aligned parallel to one another. An inlet 38 formed by the ribs 34 at the transition between the inlet flow path 28 and the flow channel 32 is inclined obliquely toward the inlet port 22, in this case at an angle α of 30°. The angle α is measured between a central longitudinal axis LE of the inlet flow path and an extension of the contour of one of the flow-guiding ribs at the inlet 38. In this case, the inlet 38 is designed to extend in a straight line. If the inlet 38 ends in a curve, the angle α between the longitudinal centerline LE and a tangent to the inlet 38 is measured.

Similarly, an angle α results between an outlet 40 at the outlet side of the flow channel 32 and a central longitudinal axis LA of the outlet flow path 30.

The inlet 38 leads to a wave crest 42, which is formed by the flow guide rib 34 and is followed by a wave trough 44. In the present embodiment, five wave crests and four wave troughs are provided between the inlet 38 and the outlet 40 over a distance corresponding to the 160 mm spacing between the inlet 38 and the outlet 40.

In the embodiment, the amplitude between the trough 42 and the crest 44 of a wave 46 formed by a single flow-guiding rib 34 is approximately 20 mm. However, in other embodiments, the amplitude may be between 10 to 30 mm, and, more typically, between 15 and 25 mm.

As shown in FIG. 2, the inlet and outlet flow paths 28, 30 taper toward the rear end of the heating chamber 6. A corresponding configuration is shown in the cross-sectional view of FIG. 3, from which it can be seen that the flow cross-section of these flow paths 28, 30 decreases continuously from the inlet into said paths in the area of the nozzles 22, 24 to the opposite end.

The flow-guiding ribs 34 are typically firmly connected to the housing base 4, for example soldered or integrally formed thereon. The housing base 4 may be a die-cast part.

The flow entering through the inlet port 22 is directed by the inlet flow path 28 into the respective flow channels 32, whereby the contour described above at the inlet 38 ensures a low pressure drop during the change in flow direction. Between the flow guide ribs 34 and, accordingly, in the flow channels, the liquid medium to be heated can be heated evenly. The waves 46 extend the effective length of the flow path within the flow channels 32 and thus enhance the heating effect. They also increase the heat-dissipating surface area exposed to the flow. Furthermore, the waves 46 create a certain amount of turbulence, thereby improving heat transfer between the flow-guiding ribs 34 and the medium.

1. An electric heating apparatus for a motor vehicle, comprising:
a housing that surrounds a heating chamber and that has inlet and outlet ports for a medium to be heated; and
an electric heating device that is thermally coupled to the heating chamber via a partition wall,
wherein an inlet flow path, extending from the inlet port, and an outlet flow path, leading to the outlet port, are formed in the housing, the inlet flow path and the outlet flow path enclosing the heating chamber between them,
wherein a plurality of flow-directing elements are arranged in the heating chamber to direct medium flow within the heating chamber, and
wherein flow channels are formed between the flow directing elements and extend between the inlet flow path and the outlet flow path, the flow channels branching off from the inlet flow path and feeding into the outlet flow path.

2. The electric heating apparatus according to claim 1,wherein the flow-directing elements project into the heating chamber from a heating chamber bottom and/or a heating chamber cover.

3. The electric heating apparatus according to claim 1, wherein the flow-directing elements are formed by flow-guiding ribs.

4. The electric heating apparatus according to claim 3, wherein the flow-guiding ribs extend parallel to one another.

5. The electric heating apparatus according to claim 1, wherein the flow channels extend substantially perpendicular to the inlet flow path and the outlet flow path.

6. The electric heating apparatus according to claim 3, wherein the flow-guiding ribs form an inlet to each flow channel, the inlet being arranged obliquely to the inlet flow path, and wherein the flow- guiding ribs form an outlet from each flow channel , the outlet being arranged obliquely relative to the outlet flow paths.

7. The electric heating apparatus according to claim 1, wherein the flow channels are wave-shaped, and wherein an inlet of the flow channels rises toward a wave crest located at a distance from the inlet of the inlet flow path, and wherein an outlet of the flow channels rises toward a wave crest located at a distance from the outlet of the outlet flow path.

8. The electric heating apparatus according to claim 3, wherein the flow channels are wave-shaped, and wherein the flow-guiding ribs form between 3 and 6 corrugations, each of the corrugations comprising a wave crest that is offset relative thereto in a direction away from the inlet of the inlet flow path and a wave trough that is offset relative thereto in the direction toward the inlet of the inlet flow path.

9. The electric heating apparatus according to claim 1, wherein the flow channels are wave-shaped, with the waves having an amplitude of between 10 mm and 30 mm.

10. The electric heating apparatus according to claim 1, wherein a flow cross-sectional area of flow channels decreases continuously with increasing distance from an inlet of the inlet flow path.

11. The electric heating apparatus according to claim 6, wherein the inlet formed by the flow-guiding ribs is arranged at an angle (α) of 10° to 60° to the inlet flow path, and wherein the outlet formed by the flow- guiding ribs is arranged at an angle (α) of 10° to 60° relative to the outlet flow path.

12. The electric heating apparatus according to claim 1, wherein the flow channels are wave-shaped, with the waves having an amplitude of between 15 mm and 25 mm.

13. The electric heating apparatus according to claim 1, wherein the flow channels that are located closer to the ports have a smaller width than the flow channels located further away from the inlet and outlet ports.

14. The electric heating apparatus according to claim 1, wherein a height of the heating chamber decreases with increasing distance from the inlet and outlet ports .

15. The electric heating apparatus according to claim 1, wherein a flow cross-section of the inlet flow path decreases continuously with increasing distance from the inlet port.

16. The electric heating apparatus according to claim 1, wherein a flow cross-section of the outlet flow path decreases continuously with increasing distance from the outlet port.

17. The electric heating apparatus according to claim 1, wherein the inlet port and the inlet flow path lie in a single plane, and wherein the inlet flow path extends in line with the inlet port, and wherein the outlet port and the outlet flow path lie in a single plane and the outlet flow path extends in line with the outlet port.
